(19) United States
(12) Patent Application Publication
(10) Pub. No.: US 2025/0249702 A1
(43) Pub. Date: Aug. 7, 2025

(54) PROCESS FOR DECORATING A METAL SUBSTRATE

(71) Applicants: ACTEGA DO BRASIL TINTAS E VERNIZES LTDA., Santana de Parnaíba (BR); COMPANHIA BRASILATA LABS, Jundiaí (BR)

(72) Inventors: Antonio GALHARDO SEGURA, São Caetano do Sul (BR); Augusto FERREIRA FRANÇA, Sumaré, São Paulo (BR)

(21) Appl. No.: 18/857,639

(22) PCT Filed: Apr. 19, 2023
(86) PCT No.: PCT/BR2023/050123

§ 371 Date: Oct. 17, 2024

(30) Foreign Application Priority Data
Apr. 20, 2022 (EP) 22169066.2

(51) Int. Cl. B44C 1/17; B05D 1/28; B44C 5/04

(52) U.S. Cl. CPC B44C 1/1716; B05D 1/28; B44C 5/0415; B05D 2508/00

(57) ABSTRACT

A process for decorating a metal substrate, in particular a metal substrate that is used as a can for food or beverage or for aerosols, whereby the decoration is printed using a digital printer. The process includes the following steps: applying a coating composition to the metal substrate; curing the coating composition at a temperature for a time sufficient to obtain a tack-free coating; printing the decoration on a polymer film using a digital printer; laminating the polymer film with the decoration onto the coated metal substrate, whereby the decoration is positioned between the surface of the coated metal substrate and the polymer film, and during lamination heating to a temperature and applying a pressure, and after the lamination exposing the substrate to a temperature a time sufficient to fully cure the coating

### CROSS-REFERENCE TO RELATED APPLICATIONS

This application is a 35 U.S.C. § 371 National Stage patent application of PCT/BR2023/050123 filed 19 Apr. 2023, which claims the benefit of European patent application 22169066.2 filed 20 Apr. 2022, the disclosures of which are incorporated herein by reference in their entirety.

### TECHNICAL FIELD

The present disclosure relates to a process for decorating a metal substrate, in particular a metal substrate that can be used as a container for food—general line or aerosol cans.

### BACKGROUND

Metal packaging is the key to many food safety concerns or to maintain the correct shelf life of chemicals or cosmetics. Such packaging is strong and seamless and provides a durable solution for storing food, blocking out contaminants or light (e.g., UV radiation). Aluminum, electrolytic tinplate or tin tree steel are most often used as the metal substrate for such packaging.

To identify the content of such packaging and also to identify the producer of such container, in most cases a decoration is applied to the outside of the packaging with such information. Often the decoration of the packaging has some attractive color or design and as such also acts as a marketing tool.

In a conventional process for making a metal substrate that can be used as packaging, a coating, clear or white is applied to the substrate and thereafter a decoration is printed on the substrate using a well-known printing technique, for example by offset lithographic printing. In this process ink is transferred in the desired pattern from the surface of a aluminum plate to a rubber blanket and then to the metal substrate. This process has a number of drawbacks, for example:
In each pass through the offset lithographic printing machine, only one color at a time can be printed on the substrate. For a decoration with multiple colors, this means that the substrate needs to pass the printing machine several times and needs to be aligned carefully before each printing pass;
A multicolor offset printing machine is composed by many single-color stages aligned. In this case the substrate passes over every stage and each color of ink is applied separately, there is one image plate per color.
The image needs to be aligned for each color. The density of the color needs to be carefully adjusted regarding the particular run. The operator needs to adjust the ink/water balance to ensure full and steady ink flow for accurate color reproduction. This setup process consumes a lot of time.
A small batch run is produced after every setup adjustment to check all parameters above. A lot of time and material are wasted at this stage. Since the offset lithographic printing process has a slow and difficult setup, normally several passes have to be made before a final decoration is obtained, the cost of the printed sheet is therefore relatively high.
Since it is not possible to change the desired decoration during the printing process, only one decoration can be printed on a multiple amount of metal substrates, which does not allow for the printing of custom-made decorations on different metal substrates.
When printed, the substrate with the same image cannot be used anymore to other image or costumer. If the substrate is not submitted to assembly line all the metal becomes waste. In many cases, to achieve optimal production cost, companies print more sheets than the original order and leave them printed on the floor for later assembly. The cost of downtime and inventory space is relatively high.
Offset Lithography presses for metal are very specialized machines. It is a machinery that comes at a very high cost price and maintenance. Also, a lot of space is needed for installation.
To protect the ink layer, an overvarnish coating is always needed,

In US20180164719 a more flexible process for decorating a metallic container is disclosed. In this process, an image is printed, using a digital printer, onto a transfer member and thereafter the image is transferred to the metal container. This process is more flexible than a lithographic or flexographic printing process, since each decoration is printed separately, and allows for printing of different decorations that are then transferred to the metal substrate. A drawback of this process is the absence of any protection of the image on the metal container, which makes the decoration prone to damaging during handling of the container. This could potentially be solved by applying of a further protective layer on the decorated can (which is not disclosed in this document), but this would include a further process step, which would make this process of decorating a can also more complex and prone to failure.

In WO2008/152137 a method for decorating a substrate using a printed adhesive film is disclosed. In this process, a decoration is printed onto a thermoplastic adhesive film and then the adhesive film is applied to the substrate. Since the decoration is on the opposite side of the adhesive, this means that once the adhesive film is applied to the substrate, the decoration is in direct contact with the environment. This process shows the same drawbacks as the process of US20180164718, viz. the absence of any protection of the image once applied on the substrate. An alternative process is also disclosed wherein the decoration is further protected with a second adhesive film. This makes this process more complex and prone to failure. Further, such a film or multiple layers of film, including the decoration, are easily removed from the substrate.

### SUMMARY

The current disclosure relates to a process that does not show the disadvantages of the known processes and that allows for the decoration of a metal substrate in a simple and flexible way. According to the process of the present disclosure, the process for decorating a metal substrate comprises the following steps:
a) Applying a coating composition to the metal substrate;
b) Curing the coating composition applied in step a) at a temperature T1 for a time sufficient to obtain a tack-free coating;
c) Printing the decoration on a polymer film using a digital printer;
d) Laminating the polymer film with the decoration onto the coated metal substrate, whereby the decoration is positioned between the surface of the coated metal substrate and the polymer film, and
e) During lamination heating to a temperature T2 and applying a pressure P1, and
f) After the lamination exposing the substrate to a temperature T3 a time sufficient to fully cure the coating.

### Definitions

Within the context of the present application, the following terms have the following meaning:
A multicolor decoration means a decoration that is not just a combination of white and black, but that has at least one further color, like, cyan, magenta, yellow, etc.;
Peak metal temperature (PMT) refers to the temperature of the relevant metal substrate. In general, the peak metal temperature is lower that the temperature of the oven or other means that is used to heat the substrate, and depends, i.a., on the residence time in the oven or more general on the time the substrate is heated.
Shelf life of a coating means the time wherein the coating shows an increase in viscosity of less than 10% when stored under ambient conditions (23° C., 65% r.h.);
A tack-free coating means that a stack of coated metal substrates can be formed and that thereafter the individual coated metal substrates can be separated without any visible damage to the coating and without any noticeable sticking of adjacent coated substrates.
A coating composition means a mixture of different ingredients that can be transferred into a coating film by exposure to elevated temperatures and/or evaporation of solvent that is present in the composition.

### BRIEF DESCRIPTION OF THE DRAWINGS

To further illustrate the current disclosure, we have included some figures. The purpose of these figures is illustration only and should not be seen as a detailed description of the current disclosure. For the sake of clarity and simplicity, some objects depicted in the figures may not be drawn to scale.

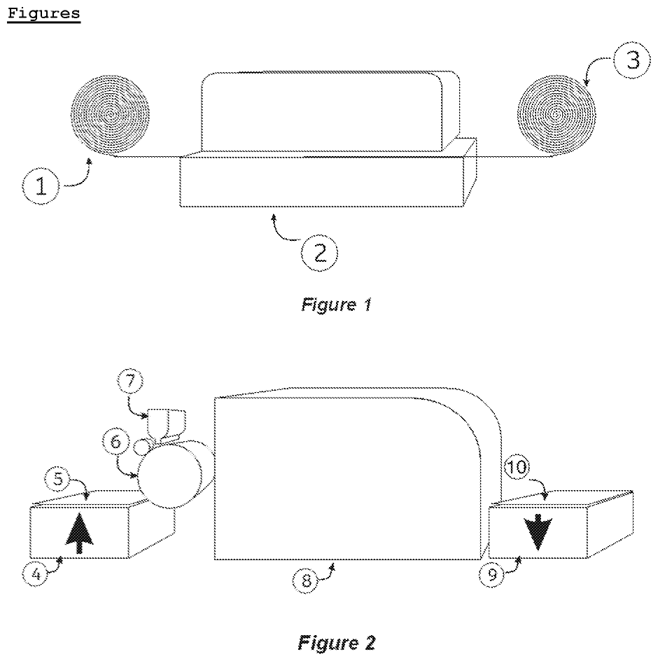

In FIG. 1 an embodiment for decorating the polymer film is illustrated. A clear polymer film (1) is passed through a digital printer (2) to be decorated. The decorated polymer film (3) is then collected by rolling it onto a bobbin.

In FIG. 2 an embodiment for coating the metal sheet is illustrated. Using a sheet feeder (4), the raw metal sheet (5) is put in a roll coater (6). In this roll coater the metal sheet is coated with a coating composition (7). After the coating process, the coated metal sheet passes through an oven to cure the coating composition. Once the coating composition is cured to a tack-free coating, the coated sheets (10) are stacked (9).

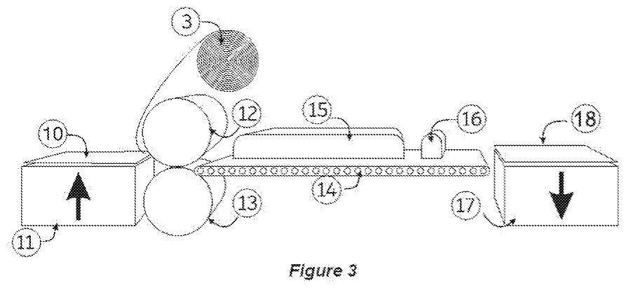

In FIG. 3 an embodiment for decorating the coated metal sheet is illustrated. The coated sheets (10) are put in a feeder system (11) to pass, together with the decorated polymer film (3), through a heated calender roll (12) and a pressure roll (13). Through heat and pressure, the decorated film is laminated to the coated sheet. The now laminated coated sheet is discharged on a conveyor belt (14) equipped with a heating system (15) above the belt. After a heat separator (16), the decorated metal sheets (18) are collected on a stack (17).

### DETAILED DESCRIPTION OF THE DRAWINGS

The metal substrate that is used in the process of the present disclosure can be a thin metal plate suitable for use as a food or general line or aerosol cans. Aluminum, electrolytic tinplate or Tin Free Steel is normally used for such metal substrate. Metal substrates used for food or beverage packaging normally have a thickness in the range from 0,1-0.5 mm.

The metal substrate that is used in the process of the present disclosure can be flat or curved. If the substrate is flat, it can be formed into the desired shape as a food or beverage container in a further process step. However, it is also possible to use the process of the present disclosure to put a decoration on a pre-formed can or container.

The coating composition that is applied to the metal substrate can be a clear coating composition or a white coating composition. A clear coating composition is typically used when it is desired to have the surface of the container visible in combination with the decoration. A white coating composition is typically used to completely cover the surface of the substrate.

The coating composition is applied to protect the substrate from corrosion, and to act as an adhesive layer for the polymer film carrying the decoration. To allow for an environmentally friendly process, the initial curing temperature of the coating composition should be in the range of 130-140° C. peak metal temperature (PMT), preferably in the range from 130-140° C. PMT. After the initial curing, the coating should be tack-free. If the temperature for this initial step is higher than 140° C. PMT, the amount of energy needed to cure the coating would be rather high, if the curing temperature is below 90° C. the storage stability of the coating will be affected, and the self-life of the coating would be limited. Normally for these types of coatings a shelf-life of at least 3 months, more preferably of at least 6 months is desired. The initial curing is done for 10-12 minutes at the PMT in the range of 130-140° C.

It was found that a coating composition that contains from 75-80 wt. % of a saturated polyester resin (where the wt. % is based on the solid content of the coating without any pigment(s)) is highly suitable to be used as a coating composition in the process according to the present disclosure. The coating composition is normally solvent based, where solvent naphtha and butyl-glycol are some of the preferred solvents. Other ingredients that are optionally present in the coating composition are epoxy acrylate resins, blocked polyisocyanate resins, and melamine resins. To allow for a tack-free coating after a relatively short initial curing stage, the coating composition also contains a small amount of lanolin, normally the lanolin content if from 0,02 to 0.06 wt. % (where the wt. % is based on the solid content of the coating without any pigment(s)).

In parallel with the process to apply a coating composition to the metal substrate, or following such process, the decoration it printed on a polymer film using a digital printer. Typically, the polymer film is flexible and has a thickness in the range from 5 to 50 μm. Normally, a type of film is used that is well known in the art, such as a polyester film or a polycarbonate film. In principle, any suitable digital printer can be used to print the decoration on the polymer film. The decoration that is printed on the polymer film can have a single color, is a black and white image (plus various shades of gray) or is a multicolor image.

The polymer film with the decoration printed thereon is then laminated on the tack-free coated metal substrate. In this process step, the side of the polymer film that carries the decoration is laminated on the coated substrate, so after completion of this lamination process, the decoration is positioned between the surface of the coated substrate and the polymer film. In this lamination process care should be taken that the decoration and/or the polymer film remain their original dimensions, so care should be taken that no stretching or wrinkling of the polymer film occurs in this lamination process. In one embodiment of the process of the current disclosure, this lamination process is done in two steps. In step 1, the polymer film with the decoration is laminated onto the coated substrate at a gentle pressure at a PMT in the range from 110-140° C., thereafter, in step 2, the pressure is increased, and lamination is continued at a PMT in the range from 130-170° C. At this latter temperature, the coating is finally fully cured for about 10 minutes. More schematically, the two-step lamination process can be described as a process wherein the polymer film with the decoration is laminated onto the coated metal substrates, wherein in step 1 the lamination is done at a temperature T_{2,1} and a pressure P_{2,1}, and in step 2, the lamination is continued at a temperature T_{2,2} and a pressure P_{2,2}, wherein T_{2,1}<T_{2,2} and P_{2,1}<P_{2,2}.

It was found that after the lamination is completed, the decoration adheres firmly to the coated substrate. It was further found that the adhesion of the decoration to the coated substrate is better than the adhesion to the polymer film, such that when the polymer film is removed from the substrate, the decoration remains on the coated substrate.

The metal substrate that is obtained through the process of the present disclosure can thereafter be formed into any form or shape, for example it can be formed into a container or packaging material for food or beverages. For example, if the metal substrate is a thin plate, it can be formed into a container through a metal shaping process, such as a deep-drawing technique or through stamping.

1. A process for decorating a metal substrate, the process includes the following steps:
a) applying a coating composition to the metal substrate;
b) curing the coating composition applied in step a) at a temperature T1 for a time sufficient to obtain a tack-free coating;
c) printing the decoration on a polymer film using a digital printer;
d) laminating the polymer film with the decoration onto the coated metal substrate, whereby the decoration is positioned between the surface of the coated metal substrate and the polymer film, and
e) during lamination heating to a temperature T2. and applying a pressure P1, and
f) after the lamination exposing the substrate to a temperature T3 a time sufficient to fully cure the coating.

2. A process according to claim 1, wherein the metal substrate is a thin metal plate.

3. A process according to claim 1, wherein the metal substrate, after lamination of the polymer film with the decoration, is formed into a container for food or general line or aerosol cans.

4. A process according to claim 1, wherein the coating composition applied in step a) is a white coating composition or a clear coating composition.

5. A process according to claim 1, wherein the decoration is a multicolor decoration.

6. A process according to claim 1, wherein the coating composition comprises from 75-80 wt. % of a saturated polyester resin, 0,02 to 0.06 wt. % of lanolin, and solvent naphtha or butyl glycol, wherein the wt. % is based on the solid content of the coating composition without any pigment(s).

7. A process according to claim 1, wherein step e) is a two-step lamination process, wherein in step 1 the lamination is done at a temperature T_{2,1} and a pressure P_{2,1}, and in step 2, the lamination is continued at a temperature T_{2,2} and a pressure P_{2,2}, wherein T_{2,1}<T_{2,2} and P_{2,1}<P_{2,2}.

8. A process according to claim 1, wherein T_{2,2}≤T3

9. A metal container of packaging for food or general line or aerosol cans wherein at least a part of the container is decorated through the process of claim 1.
